(19) United States
(12) Patent Application Publication
(10) Pub. No.: US 2023/0063583 A1
(43) Pub. Date: Mar. 2, 2023

(54) BACKBOARD ALIGNMENT OF MECHANICAL CPR DEVICE

(71) Applicant: PHYSIO-CONTROL, INC., Redmond, WA (US)

(72) Inventors: Tyson Taylor, Bothell, WA (US); Sara Lindroth, Lund (SE); Alexey Titov, Woodinville, WA (US); Anders Nilsson, Lund (SE); Fred W. Chapman, Newcastle, WA (US); Steven Chester, Kirkland, WA (US); Robert G. Walker, Seattle, WA (US); Steven B. Duke, Bothell, WA (US)

(73) Assignee: PHYSIO-CONTROL, INC., Redmond, WA (US)

(21) Appl. No.: 17/898,291

(22) Filed: Aug. 29, 2022

Related U.S. Application Data
(60) Provisional application No. 63/238,412, filed on Aug. 30, 2021.

(51) Int. Cl. A61H 31/00

(52) U.S. Cl. CPC A61H 31/006; A61H 31/005; A61H 2031/001; A61H 2031/002; A61H 2201/165; A61H 2201/1207

(57) ABSTRACT

An alignment device for assisting a rescuer for correctly aligning a mechanical cardiopulmonary resuscitation (CPR) device. The alignment device can guide positioning of the backboard so that the backboard is correctly positioned prior to connecting an upper portion of the mechanical CPR device to the backboard. The alignment device can also include positioning the mechanical CPR device without a backboard or positioning the backboard and the upper portion of the mechanical CPR device nearly simultaneously.

### CROSS-REFERENCES TO RELATED APPLICATIONS

This application is a non-provisional application of, and claims priority to, U.S. Provisional Pat. Application No. 63/238,412, filed Aug. 30, 2021, the disclosure of which is incorporated herein by reference in its entirety.

### BACKGROUND

In certain types of medical emergencies a patient’s heart stops working. This stops the blood flow, without which the patient may die. Cardio Pulmonary Resuscitation (CPR) can forestall the risk of death. CPR includes performing repeated chest compressions to the chest of the patient to cause their blood to circulate. CPR can also include delivering rescue breaths to the patient. CPR is intended to merely maintain the patient until a more definite therapy is made available, such as defibrillation.

Traditionally, CPR has been performed manually. A number of people have been trained in CPR, including some who are not in the medical professions. However, manual CPR might be ineffective, and being ineffective it may lead to irreversible damage to the patient’s vital organs, such as the brain and the heart.

The risk of ineffective chest compressions has been addressed with CPR chest compression machines. Such machines have been known by a number of names, for example CPR chest compression machines (CCCM), mechanical CPR devices, cardiac compressors and so on.

The correct positioning of a mechanical CPR device on a patient’s chest is critical to provide effective chest compressions. However, during an emergency situation and/or with first time or rare rescuers, it can be difficult to correctly place the backboard with respect to the patient such that the upper portion of the mechanical CPR device is aligned correctly. During the time a CPR chest compression machine is aligned, a patient may not be receiving manual chest compressions. If the upper portion is not aligned correctly, a rescuer must reposition the backboard with respect to the patient, resulting in additional time that CPR compressions are not performed. The longer it takes to align the mechanical compression device can be detrimental to a patient. The backboard of the mechanical CPR is positioned first before attaching the upper portion of the mechanical CPR device. If the backboard is incorrectly positioned, it can waste valuable time having to readjust the backboard with respect to the patient.

Configurations of the disclosed technology address shortcomings in the prior art.

### BRIEF DESCRIPTION OF THE DRAWINGS

FIG. 1 is a perspective view of an exampled mechanical compression device.

FIG. 2 is a schematic block diagram of a control system for a mechanical compression device according to some examples of the disclosure.

FIG. 3 is a perspective view of an alignment device for aligning a backboard for a mechanical compression device accurately according to some examples of the disclosure.

FIG. 4 is a perspective view of another alignment device for aligning a backboard for a mechanical compression device accurately according to some examples of the disclosure.

FIG. 5 is a perspective view of another alignment device for aligning a backboard for a mechanical compression device accurately according to some examples of the disclosure.

FIG. 6 is a perspective view of another alignment device for aligning a backboard for a mechanical compression device accurately according to some examples of the disclosure.

FIG. 7 is a perspective view of another alignment device for aligning a backboard for a mechanical compression device accurately according to some examples of the disclosure.

FIG. 8 is a perspective view of a backboard with alignment markings according to some examples of the disclosure.

FIG. 9 is a perspective view of a backboard with load cells according to some examples of the disclosure.

FIG. 10 is a perspective view of an example mechanical compression device without a backboard according to some examples of the disclosure.

FIG. 11 is a perspective view of another example mechanical compression device without a backboard according to some examples of the disclosure.

FIG. 12 is a perspective view of a one-piece mechanical compression device according to some examples of the disclosure.

### DETAILED DESCRIPTION

Disclosed herein are various examples for aligning a backboard of a mechanical CPR device properly or more accurately, prior to placing an upper portion over a chest of a patient, to prevent having to adjust the backboard after the initial placement. Some of the various examples disclosed herein can also place an upper portion over a chest of a patient without a backboard so that CPR is not delayed by positioning or adjusting a backboard.

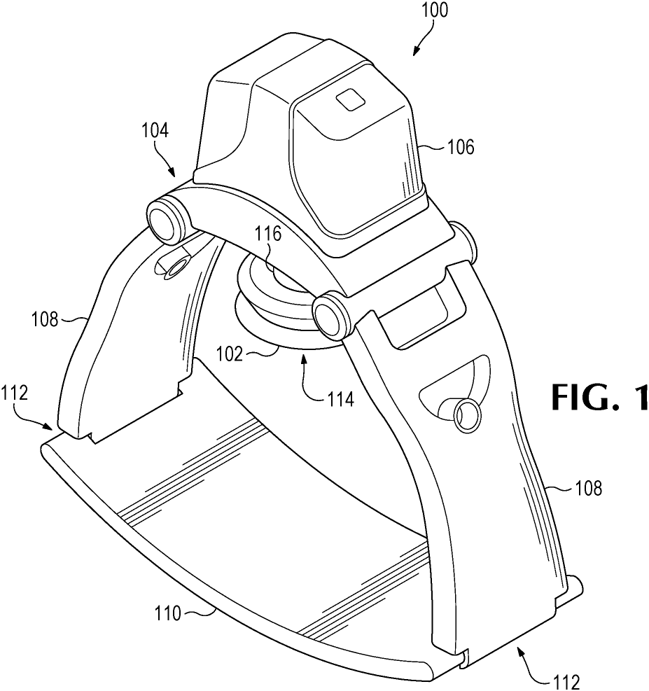

FIG. 1 is a front view of an example mechanical CPR device 100 of FIG. 1 with an upper portion 104, also referred to herein as a support structure, and a backboard 110. While FIG. 1 is described to illustrate a mechanical compression device, examples of the disclosure are not limited to this particular type of compression device, but may be used with any compression device that utilizes a backboard attached to an upper portion when providing compressions.

As will be understood by one skilled in the art, the mechanical CPR device 100 may include additional components not shown in FIG. 1. As illustrated in FIG. 1, the mechanical CPR device 100 may include a central unit 106 in the upper portion 104. The upper portion 104 may also include support legs 108 that can removably attach to the backboard 110. The support leg 108 and the backboard 110 meet at a junction 112 between the support leg 108 and the backboard 110. The support legs 108 can attached to first and second connectors of the backboard 110.

The support leg 108 may be configured to support central unit 106 at a distance from the backboard 110. For example, if the backboard 110 is underneath the patient, on the patient’s back, then the support legs 108 may support the central unit 106 at a sufficient distance over the backboard 110 to allow the patient to lay within a space between the backboard 110 and the chest compression mechanism 114, while positioning the chest compression mechanism 114 over the patient’s chest.

The central unit 106 is configured to deliver CPR chest compressions to the patient. The compression mechanism 114 of the central unit 106 may include, for example, a motor-driven piston 116 configured to contact the patient’s chest through the suction cup 102 to provide the CPR compressions. The central unit 106 may also include a number of electronic components to drive the motor-driven piston 116. Attached to the motor-driven piston 116 is a suction cup 102 which adheres to the chest of the patient during chest compressions. The suction cup 102 can allow the motor-driven piston 116 to lift the chest back to a resting height, or provide a full decompression of the chest of the patient, when the motor-driven piston 116 is retracted from an extended position.

As will be discussed in more detail below, an alignment device may be utilized in some examples to assist with aligning the backboard 110 correctly with the patient, to prevent a rescuer from attaching the upper portion 104 before the backboard 110 is correctly aligned.

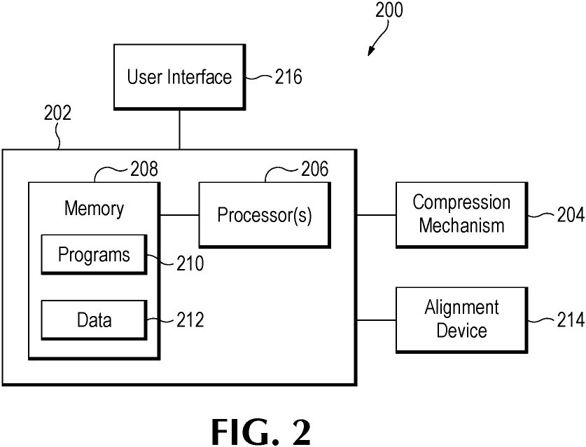

FIG. 2 illustrates an example schematic block diagram of a mechanical compression device system 200. As will be understood by one skilled in the art, the mechanical compression system 200 may include additional components not shown in FIG. 2. Further, the components of the mechanical compression device system 200 may not be included in the same device, but rather may be located in different parts of the mechanical compression device system 200 and communicate either by wired or wireless signals. The mechanical compression device system 200 includes a controller 202, which may be in electrical communication with a compression mechanism 204, which may include a piston and a suction cup or pressure pad. While a single controller 202 is shown for ease, multiple controllers 202 may operate together to accomplish the various features discussed below.

The controller 202 provides instructions to the compression mechanism 204 to operate the compression mechanism 204 at a number of different rates, waveforms, depths, heights, duty cycles or combinations thereof that change over time. Example chest and/or abdomen manipulation instructions or protocols include compressing a chest and decompressing and/or expansions of a chest.

The controller 202 may include one or more processors 206, which may be implemented as any processing circuity, such as, but not limited to, a microprocessor, an application specific integration circuit (ASIC), programmable logic circuits, etc. The controller may further include a memory 208 coupled with the processor 206. Memory 208 can include a non-transitory storage medium that includes programs 210 configured to be read by the processor 206 and be executed upon reading. The processor 206 is configured to execute instructions from memory 208 and may perform any methods and/or associated operations indicated by such instructions. Memory 208 may be implemented as processor cache, random access memory (RAM), read only memory (ROM), solid state memory, hard disk drive(s), and/or any other memory type. Memory 208 acts as a medium for storing data 212, such as instructions for the compression mechanism 204 based on a type of suction cup attached, event data, patient data, etc., computer program products, and other instructions.

Controller 202 may further communicate with an alignment device 214. The controller 202 can receive signals or other data from an alignment device 214, as discussed below. The alignment device 214 may include sensors, mechanical alignment devices, image capturing devices, etc.

The controller 202 may be located separately from the compression mechanism 204 and may communicate with the compression mechanism 204 through a wired or wireless connection. As mentioned above, the controller 202 may include multiple controllers, such as one controller 202 being located in the central unit 106 and a controller being located within the backboard 110. However, examples of the disclosure not limited to this configuration and the controller(s) 202 can be located anywhere within the system. The controller 202 also electrically communicates with a user interface 216. As will be understood by one skilled in the art, the controller 202 may also be in electronic communication with a variety of other devices, such as, but not limited to, a communication device, another medical device, etc.

Operations of the mechanical CPR device 100, or any of the devices discussed below, may be effectuated through the user interface 216. The user interface 216 may be external to or integrated with a display. For example, in some examples, the user interface 216 may include physical buttons, while in other examples, the user interface 216 may be a touch-sensitive feature of a display. The user interface 216 may be located on the mechanical CPR device 100, the backboard 110, and/or may be located on a remote device, such as a smartphone, tablet, PDA, and the like, and is also in electronic communication with the controller 202. In some examples, controller 202 can receive a rate, a waveform, and/or depth input from the user interface 216 and, responsive to the rate, the waveform, and/or depth input, cause the compression mechanism 204 to move to adjust the rate, waveform, and/or depth of the compression, decompression, or expansions during a session.

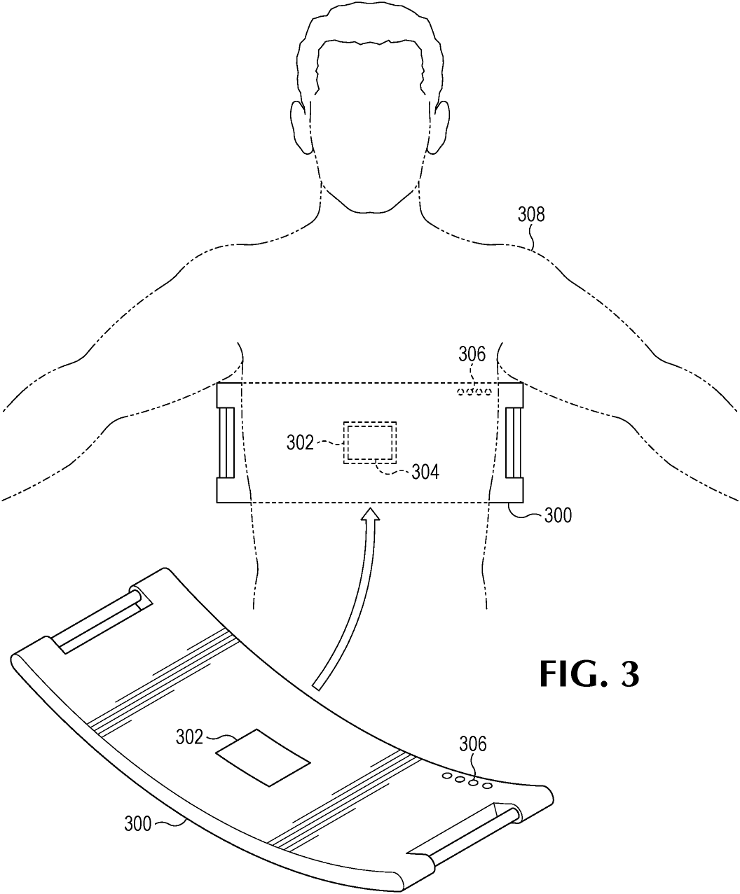

In some examples, the alignment device 214 may include alignment sensors 302 and 304 that can transmit signals to the controller 202 and/or any other processor within the rescue system, as shown in FIG. 3. Backboard 300 shown in FIG. 3 can be used in place of backboard 110 of FIG. 1. The alignment sensors 302 and 304 can include a backboard sensor 302 and a patient sensor 304. The backboard sensor 302 can be located on or within the backboard 300. The patient sensor 304 can be placed or positioned on the back of the patient 308 may be, for example, a removable sensor, that can be disposed on the back of the patient 308 at a location that corresponds to the compression point on a chest of the patient 308. For example, the sensor may be placed between the shoulder blades of a patient 308 at a location that corresponds to a compression point on a chest of the patient 308.

The backboard 300 can be positioned under the patient 308 and a backboard sensor 302 and the patient sensor 304 can each transmit signals to the controller 202 to determine whether the backboard 300 is located in the correct position. For example, the sensors 302 and 304 may transmit a signal to the controller 202 to indicate the proximity of the sensors 302 and 304 to each other. If the sensors are not within a predetermined distance or threshold to each other, then a signal may be output to a rescuer, either visually or orally, to adjust the position of the backboard 300. The sensors 302 and 304 can be any sensors which can detect proximity to each other, such as, but not limited to, electromagnetic sensors and/or optical sensors.

In other examples, as mentioned above, the controller 202 may be located, for example, within the backboard 300 itself. The backboard 300 may include a display (not shown) and/or any other visual indicators to indicate the alignment of the patient 308 on the backboard 300. For example, the backboard 300 may include a number of LEDs 306 that light up based on the proximity of the sensors 302 and 304 to each other. Examples of the disclosure, however, are not limited to the backboard 300 including LEDs 306. Rather, a small display may be provided on the backboard 300 and/or the display for the central unit 106 may be utilized to alert a rescuer. Finally, in some examples, no display is provided and an audio alert may be generated for the rescuer.

As an example, if the sensors 302 and 304 are not within a threshold distance, then the LEDs 306 may light up a particular color and/or only particular LEDs 306 may light up. If the sensors 302 and 304 are within the threshold distance, the LEDs 306 may light up a different color and/or particular LEDs 306 may light up to indicate to a rescuer that the backboard 300 is in correct alignment. For example, multiple LEDs 306 may be provided, and a single LED 306 is lit when the sensors 302 and 304 detect each other but are not within the threshold distance. The number of LEDs 306 that light up can increase as a rescuer places the backboard 300 in the correct locations. When sensors 302 and 304 are within the predetermined threshold, all the LEDs 306 may be lit. A rescuer can then receive real-time feedback on the backboard 300 location relative to the patient 308 to ensure placement of the backboard 300 is correct before attempting to place the upper portion 104 over the patient 308.

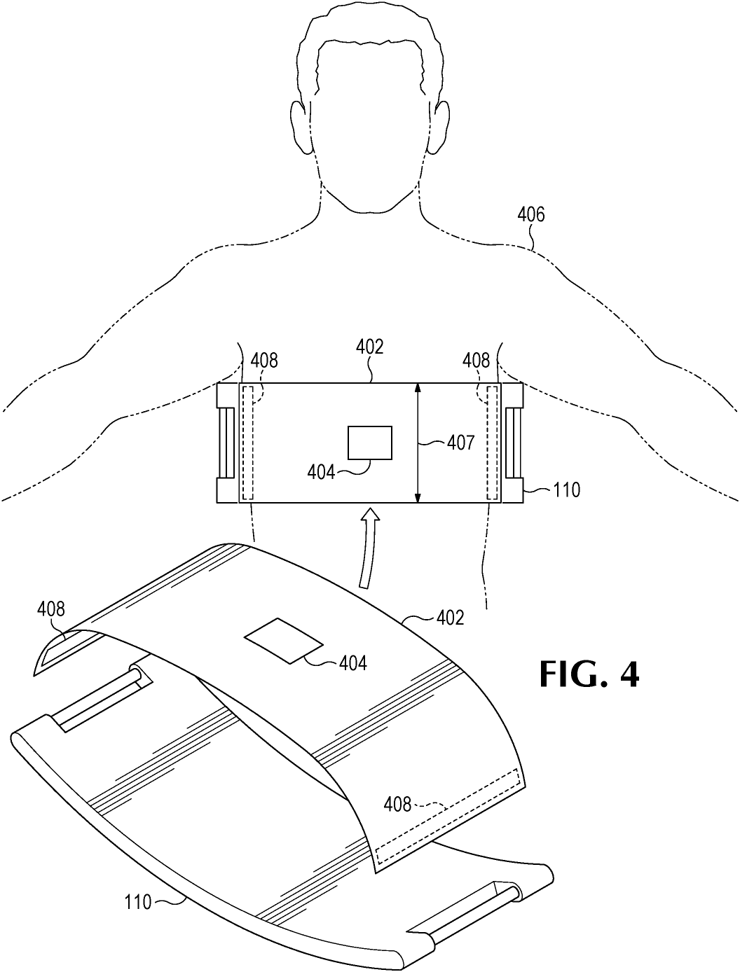

An alignment device 214, however, is not limited to the sensors 302 and 304 discussed above. FIG. 4 illustrated another example of an alignment device 214 according to some examples of the disclosure. The alignment device 214 of FIG. 4 can include a strap 402, which may be flexible or semi-flexible. The strap 402 can be any shape that fits over a chest of a patient 406, such as flat, tubular in shape, a string, a rigid arm, etc. The strap 402 may include a marker 404 for indicating a desired compression point. While the marker 404 is shown as a rectangle in FIG. 4, the marker 404 is not limited to this shape and may be any shape desired, such as a circle, star, etc. Additionally or alternatively, the marker 404 may be a change in color on the strap to indicate the compression point.

A rescuer can place the strap 402 on a chest of the patient 406 so that the marker 404 aligns with a desired compression point. For example, the strap 402 may be placed during compressions to ensure the marker 404 is in the correct position. However, examples of the disclosure are not limited to applying the strap 402 during compressions and the strap 402 may be applied at any time to the patient 406.

The strap 402 may contain an adhesive for adhering to the patient. For example, the strap 402 may have an adhesive on a side of the strap that abuts the patient 406. The adhesive may be placed anywhere along the strap, including on the entirety of the side of the strap 402 that is adjacent to the patient 406. In some examples, the adhesive 408 may be placed at least on the ends of the strap 402. When the marker 404 of the strap 402 is placed on a compression point, then sides of the strap can then be adhered to the sides of the patient 406.

Once the strap 402 is placed on the patient 406, then the backboard 110 can be positioned behind the patient 406 and aligned with the sides of the strap 402. A lateral width 407 of the strap 402 can be the entire width of the backboard 110, so that the backboard 110 should align with the sides of the strap 402 that are adhered to the patient 406. An example of such a configuration is illustrated in FIG. 4. In other examples, the strap 402 may be thinner or narrow than the backboard 110, but the backboard can include markings to align with the strap 402. While examples of such markings are not shown in FIG. 4 , the markings would essentially align with where the side edges of the strap 402 are illustrated in FIG. 4. This can assist a rescuer with placing the backboard 110 at the correct location initially, rather than having to readjust the backboard 110 after attempting to attach the upper portion 104 and learning that the backboard 110 is in the wrong position.

Additionally or alternatively, the strap 402 may also indicate whether the mechanical CPR device will fit the patient 406. Many mechanical CPR devices have a range of patient sizes that can be treated, but do not work effectively on patients that are either too small or are too large for the mechanical CPR device. The strap 402 may include markings or other indicators on the sides of the straps to allow a rescuer to quickly determine whether the CPR device will fit the patient 406.

For example, the strap 402 may include a marking at a far edge of one side to indicate the maximum size of the patient 406. If the strap 402 is placed on the patient 406 and the marking does not meet the side of the patient 406, a rescuer can quickly determine that the mechanical CPR device 100 cannot be used and can resume or continue manual compressions. Additionally or alternatively, the strap 402 can include a marking on at least one side to indicate a minimum size of a patient 406. If the strap 402 is placed on the patient 406 and the small patient size marking is beyond the side of the patient 406, then a rescuer can quickly determine that the patient 406 is too small for the mechanical CPR device 100. This can prevent the loss of valuable time of trying fit the mechanical CPR device 100 around the patient, only to realize that the patient is too small or too large for the mechanical CPR device.

In some examples, the strap 402 may be located within or as a part of the backboard 110. For example, a rescuer may place the backboard 110 behind the patient 406 and the rescuer may then pull the strap 402, which may be wound within the backboard 110 or loosely attached, across the chest of the patient. The rescuer may use the marker 404 to determine that the backboard 110 is in the correct position or to otherwise adjust the backboard 110.

The strap 402, if attached or located within the backboard 110 may be used to determine if the patient will fit within the mechanical CPR device 100. For example, if the strap 402 does not connect to the other side of the backboard 110, a rescuer is alerted that the patient is too large for the mechanical CPR device. Additionally or alternatively, a marker 404 may be provided on the strap, and if the marker goes beyond the other side of the backboard 110, a rescuer can be alert that the patient is too small for the mechanical CPR device 100.

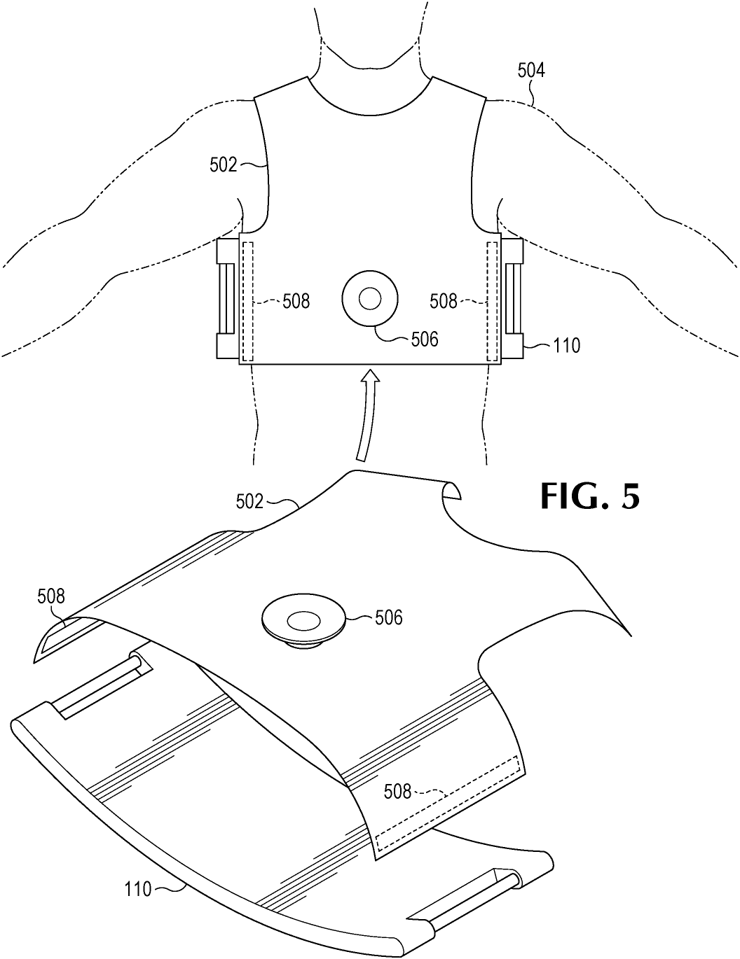

FIG. 5 illustrates another type of alignment device 214 according to some examples of the disclosure. The alignment device 214 can include a template 502 that is placed on and/or adhered to a chest of a patient 504. The template 502 may be a vest-like shape, as shown in FIG. 5. However, examples of the disclosure are not limited to a vest-like shape and the template may be any shape desired to fit across the chest of the patient 504. The template 502 may be rigid, flexible, or semi-flexible. For example, the template 502 may be a rigid shell that is placed over the chest of the patient 504. In other examples, the template 502 may be flexible to mold to the shape of the chest of the patient 504. As an example, the template 502 may be a clear plastic bandage, such as, but not limited to, Tegaderm™, that is flexible and adheres to the skin of a patient 504. Similar to the strap 402, the template 502 can include a marker 506 to be located on a compression point of the patient.

In some examples, the marker 506 may be any marker that marks the desired compression point. To position the template on the patient 504, the marker 506 is aligned with the desired compression point. When the marker 506 is aligned with the desired compression point, then the sides of the template can include a marker 508 or other indicator to mark the location the backboard 110 should be placed. A rescuer can position the backboard 110 under the patient 504 and quickly adjust the backboard 110 if needed, prior to attaching the upper portion 104.

In some examples, the marker 506 may be a hole within the template that a suction cup or pressure pad of the mechanical CPR device 100 can fit within, particularly if the template 502 is rigid. In other examples, the marker 506 may be a suction cup (an example of which is illustrated in FIG. 5) built-in to the template 502. In such an example, the piston 116 can be extended down from the upper portion 104 to attach to the suction cup within the template 502.

Similar to the strap 402, the template 502 can include markings to indicate whether the mechanical CPR device 100 can accommodate the size of the patient 504. The sides of the template 502 may include markings to indicate that the patient is too small or that the patient is too large for the mechanical CPR device 100. Again, this prevents the rescuer wasting valuable compression time to try to fit the mechanical CPR device 100 only to find out the patient is too large or too small. It also can help prevent a rescuer from making the assumption that the patient will not fit, as the strap 402 and template 502 are quick ways to check without severely disrupting manual compressions.

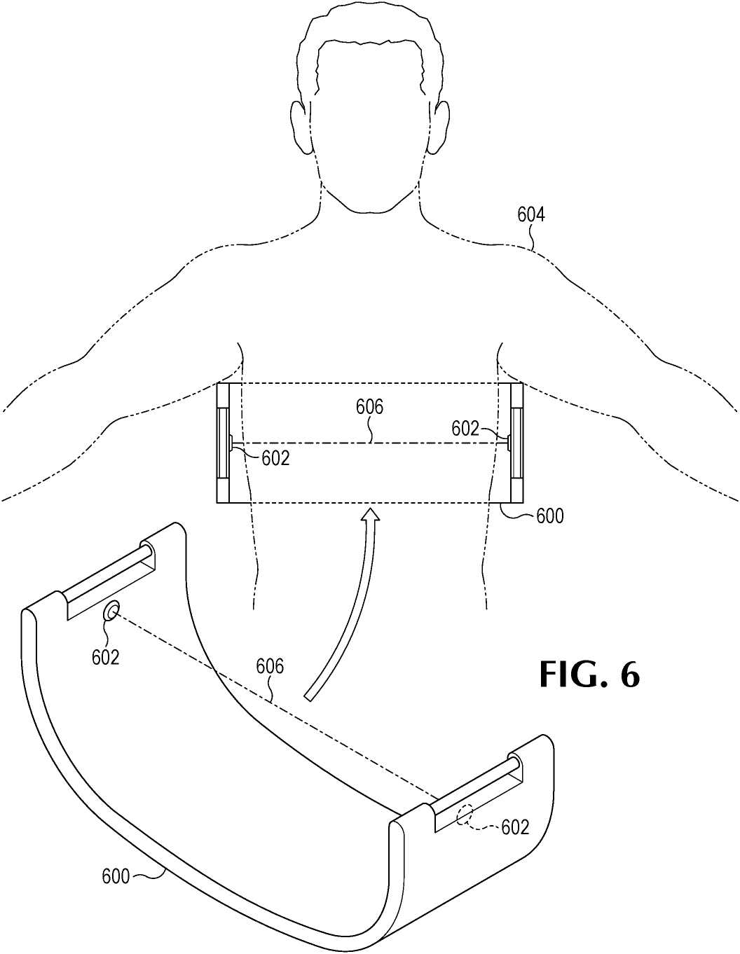

FIG. 6 illustrates another example of an alignment device for the mechanical CPR compression device 100. As mentioned above, the backboard 600 includes first and second connectors to attach to support legs 108. The backboard 600 includes an elongated section that extends between the first and second connectors.

In the example of FIG. 6, the alignment device 214 includes a backboard 600 having one or more light emitting devices 602 to shine across a chest of a patient 604. The backboard 600 can be used in place of backboard 110 in FIG. 1. While the light emitting devices 602 are shown on both sides of the elongated portion of the backboard 600, the light emitting devices 602 may be included on only one side of the backboard 600 in some examples. The light emitting devices 602 are located high enough on the backboard 600 to shine a light 606 on the patient 604.

In some examples, the light emitting devices 602 may also be used to alert a rescuer that the patient 604 may be too large or too small for the mechanical CPR device 100. For example, the light emitting devices 602 may be angled such that if the emitted light is not near a center a chest of a patient, it can indicate to the rescuer that the patient is too small. As another example, if the emitted light 606 from the light emitting devices 602 does not shine on the chest of the patient 604 at all, that can indicate to a rescuer that the patient is too large for the mechanical CPR device 100.

However, examples of the disclosure are not limited to these two examples and other means may be used to indicate whether the patient is appropriately sized for the mechanical CPR device 100. For example, different color light emitting devices may be placed on or within the elongated portion of the backboard 600 and be angled to alert a rescuer whether the patient 604 is too large or too small for the mechanical CPR device 100.

The one or more light emitting devices 602 may generate a steady light 606 that is shone across the chest of the patient 604. Using the light 606 illuminated on the chest of the patient 604, a rescuer can ensure that the backboard 600 is aligned so that the light shines across the desired compression point. A rescuer can adjust the backboard 600 up or down to align the light 606 with the compression point.

The light emitting device(s) 602 of the backboard 600 can remain on during compressions of the patient in some examples. A rescuer can monitor the light 606 when the mechanical CPR device 100 is performing compressions and determine if there has been any change in the compression point during the mechanical CPR. For example, if the compression mechanism 114 moves outside the light 606, a rescuer is alerted that the compression point has changed.

Examples of the disclosure, however, are not limited to a steady light 606, and the light emitting device(s) 602 may output a light that is swept, rotated, oscillated, vibrated, diffused, or any other output to generate a line or other patterns on a chest of a patient 604. The light emitting device 602 of the backboard 600 can be any light emitting device such as, but not limited to, light emitting diodes and/or lasers.

In some examples, an image capturing device may be present in the system, such as on the upper portion 104 or located on the backboard 600. The image capturing device can transmit a signal with the image and a controller 202 can detect any changes in compression position by using the light output by the light emitting devices 602 as an aiming mark, such as taught by U.S. Pat. No. 10,117,804 titled “CPR CHEST COMPRESSION MACHINE WITH CAMERA,” which is incorporated herein by reference.

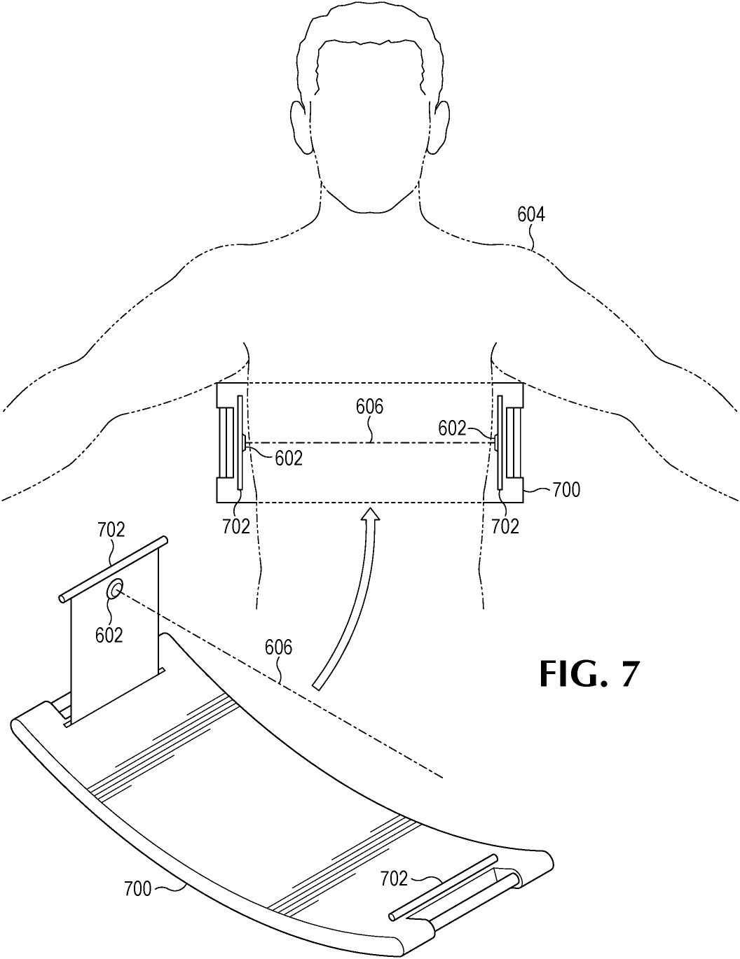

In some examples, the light emitting devices 602 may be stored within the backboard 700 itself and can be extended to determine correct alignment of the backboard 700. For example, as shown in FIG. 7, the light emitting devices 602 may be positioned on a telescoping or otherwise movable portion 702 that can extend from or retract within the backboard 700. The movable portion 702 could be included in the connectors 704 of the backboard. During positioning of the backboard 700, the movable portion 702 can be extended and the light emitting devices 602 can emit a light 606 across the chest of the patient 604900, similar to shown in FIG. 6.

FIG. 7 illustrates a first movable portion 702 extended from the backboard 700 and a second movable portion 702 retracted within the backboard 700. Examples of the disclosure however are not limited to having the light emitting devices 602 on both sides of the elongated portion of the backboard 600, and in some examples, only one movable portion 702 is provided in the backboard 700 to assist with aligning the backboard 700.

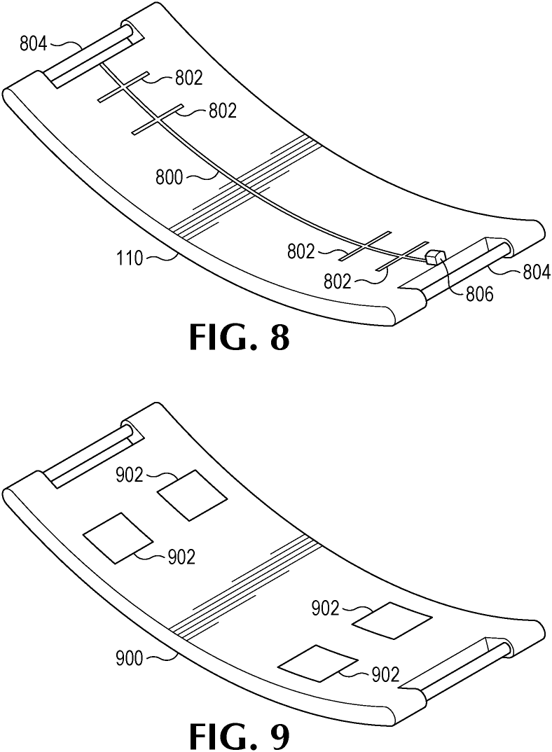

Additionally or alternatively to any of the examples described above, the backboard 110 can include a number of markers to assist with one or both of alignment and checking the size of the patient for the mechanical CPR device 100. For example, the backboard 110 may include a compression alignment line 800, as shown in FIG. 8, for a rescuer to align with the desired compression point. The backboard 110 can be adjusted behind the patient until the compression alignment line 800 is aligned with the desired compression point.

The backboard 110 may also include sizing indicator lines 802 to assist a rescuer with determining whether the mechanical CPR device 100 will fit the patient. In some examples, the backboard 110 can include two sizing indicator lines 802 on one or both sides of the backboard 110. FIG. 8 illustrates sizing indicator lines 802 on both sides of the backboard 110 but in some examples, the sizing indicator lines 802 may be provided on only one side of the backboard 110.

One sizing indicator line 802 to indicate a patient is too large for the mechanical CPR device 100 and one sizing indicator line 802 to indicate a patient is too small for the mechanical CPR device 100. The sizing indicator line 802 closest to the connector 804 can help a rescuer determine whether the patient is too large for the mechanical CPR device 100. If when the backboard 110 is properly positioned behind the back of a patient the rescuer cannot see the sizing indicator line 802 closes to the connector 804, the rescuer can quickly determine that the mechanical CPR device 100 will not work for this patient.

The sizing indicator line 802 closest to the center of the backboard 110 can be used to indicate to a rescuer that the patient is too small for the mechanical CPR device 100. If when the backboard 110 is properly positioned behind the back of a patient the rescuer can see the sizing indicator line 802 closest to the middle of the backboard 110, the rescuer can quickly determine that the mechanical CPR device 100 will not work for this patient, as the patient is too small.

In some examples, the system can include an image capturing device 806, such as a digital camera, a smart phone, a smart tablet, etc. Any image capturing device 806 may be used. While FIG. 8 shows the image capturing device 806 located on the connector 804, the image capturing device 806 can be located elsewhere within the system, including being handheld by a rescuer. The image from the image capturing device 806 may be sent the controller 202 to determine whether the mechanical CPR device 100 can fit the patient. The controller 202 or other processor can then alert a user if the mechanical CPR device 100 will not accommodate the patient and/or if the backboard 110 is not lined up correctly for the upper portion 104.

In some examples with an image capturing device 806, a sticker and/or other marker may be placed on the patient to assist with aligning. The marker may be placed on the desired compression point or may be placed along a side of the chest of the patient. In some examples, multiple markers and multiple image capturing devices 806 may be used. The controller 202 can determine the position of the patient relative to the backboard 110 based on the image captured by the image capturing device 806 using the marker and the known features of the backboard. In some examples, the image capturing device 806 may continually record video or sequences of images during the operation of the mechanical CPR device 100. The recorded video or images may be saved and later used for post even reporting.

In some examples, load cells 902 may be used within the backboard 900, as shown in FIG. 9. The load cells 902 can transmit a signal, either wired or wirelessly, to the controller 202 to alert a rescuer that the backboard 900 is not properly positioned behind the patient. While FIG. 9 illustrates four load cells 902, examples of the disclosure are not limited to four load cells 902 and more or less load cells may be used.

The load cells 902 are calibrated during manufacturing for an average weight distribution when a backboard 900 is positioned correctly behind a patient. In some examples, the load cells 902 may be calibrated for a variety of different patient sizes and/or genders. A rescuer may enter a gender and/or patient size into the user interface 216. The load cells 902 can transmit a signal to the controller 202 which can determine whether the weight distribution between the load cells is within a set threshold based on the gender and/or size of the patient. If not, an alert, either visual or audio, may be transmitted to the rescuer to adjust the patient. In some examples, the controller 202 may be able to provide more specific instructions, such as to move the backboard toward the patient’s head or feet based on the load distribution detected by the load cells 902.

In some examples of the disclosure, a mechanical CPR device without a backboard may be used to remove the complications of attempting to place the backboard 110 in the correct position behind the patient.

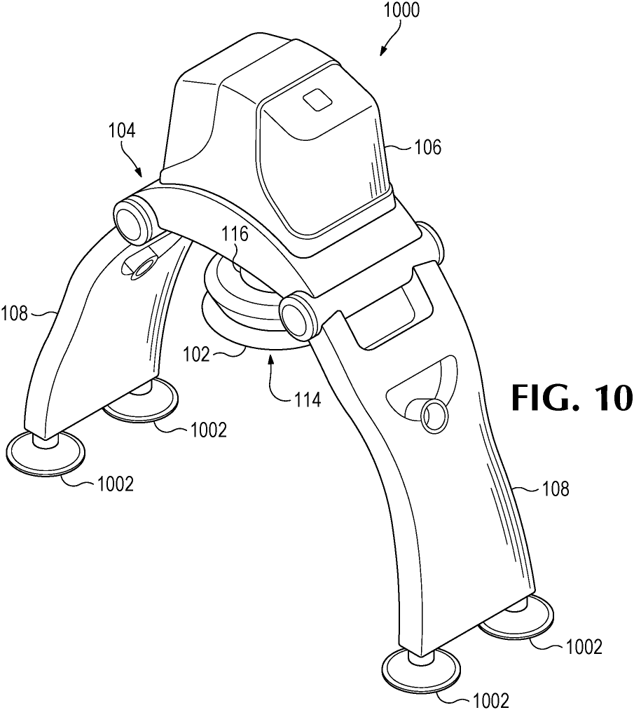

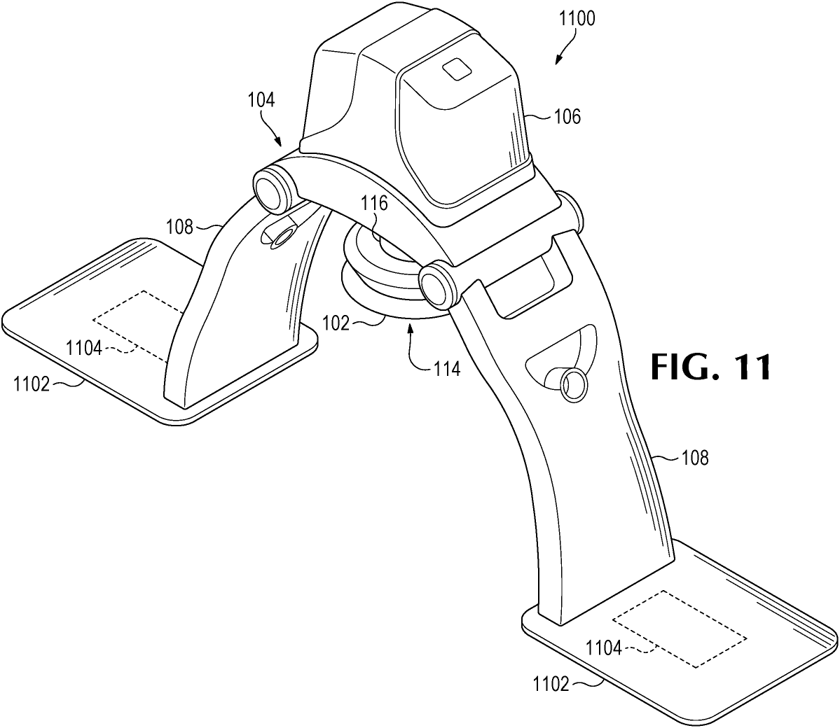

FIG. 10 illustrates an example of a mechanical CPR device 1000 without a backboard 110. In the example of FIG. 10, components that are similar or identical to the ones discussed above with respect to FIG. 1 are given the save reference numbers. For example, the mechanical CPR device 1000 can include a central unit 106, support legs 108, etc. Rather than meeting a backboard 110 at a junction 112, suction cups 1002 and/or adhesives may be used to attach the support legs 108 of the mechanical CPR device 1000 directly to a floor. While suction cups 1002 are illustrated in FIG. 10, adhesive may be used in the place of suction cups 1002, as will be understood by one skilled in the art. The suction cups 1002 and/or the adhesive can ensure that the mechanical CPR device 1100 does not life off the floor (and therefore the chest of the patient) while compressions are being provided.

In some examples, the support legs 108 can each include two suction cups 1002, as shown in FIG. 10. However, in other examples, more suction cups 1002 could be provided to assist with attaching to the floor. Further, less than four suction cups 1002 may be provided. A single suction cup 1002 on each support leg 108 may be used in some examples.

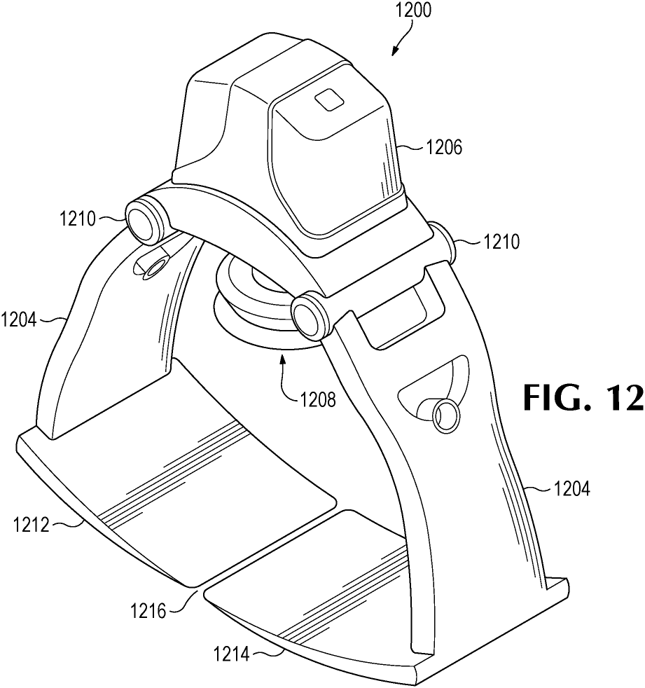

As another example, a mechanical CPR device 1100, as illustrated in FIG. 11, can include foot pedals 1102 rather than a backboard 110. In the example of FIG. 11, components that are similar or identical to the ones discussed above with respect to FIG. 1 are given the save reference numbers.

The foot pedals can extend outward from the bottom ends of the support legs 108. A rescuer can step on the foot pedals provided on the bottom ends of the support legs 108 to use the body weight of the rescuer to ensure that the mechanical CPR device 1100 does not lift off the floor while compressions are being provided to a chest of a patient. The foot pedals may be any shape.

In some examples, the foot pedals 1102 may include load cells 1104 to detect that the rescuer is standing on the foot pedals. If the load cells 1104 do not detect the rescuer, the mechanical CPR device 1100 may either output an alert and/or not operate until the rescuer is detected on the foot pedals 1102. This can help ensure that the compressions performed by the mechanical CPR device 1100 are effective and so that the mechanical CPR device 1100 does not lift off of the chest of the patient and/or the floor.

Although not shown, in addition to or alterative to the foot pedals 1102, a seat may be provided for the rescuer to sit to apply the body weight of the rescuer to the mechanical CPR device 1100. For example, a seat may be built over the central unit 106 which can accommodate a weight of the rescuer and ensure that the mechanical CPR device 1100 does not lift off the floor while providing compressions to the patient. Similar to the foot pedals 1102, the seat may have a load sensor to detect that the rescuer is sitting on the seat prior to allowing operation of the mechanical CPR device 1100.

In other examples of the disclosure, the backboard of a mechanical CPR device can be positioned at the same time as the upper portion 104. FIG. 12 illustrates a mechanical CPR device 1200 with a backboard 1202 that is affixed to the support legs 1204. The mechanical CPR device 1200 includes support legs 1204 similar to support legs 108 discussed above. The support legs 1204 can be attached to central unit 1206 which supports a compression mechanism 1208 by a hinged joint 1210. The central unit 1206 and compression mechanism 1208 are similar to the central unit 106 above and the motor-driven piston 116, respectively, discussed above.

As mentioned above, the support legs 1204 of the mechanical CPR device 1200 are fixedly attached to the backboard 1202, rather than removable attached, as shown in FIG. 1. The support legs 1204 may be attached in approximately an “L”-shaped manner or approximately 90 degrees, approximately meaning within 15% of 90 degrees. In other examples, however, the support legs 1204 may be attached to the backboard 1202 by a hinge, similar to the hinged joint 1210.

The backboard 1202 includes two separate portions 1212 and 1214. Each portion 1212 and 1214 is attached to a respective support leg 1204 of the mechanical CPR device 1200. In the example shown in FIG. 12, a gap 1216 is present between the portions 1212 and 1214. The gap 1216, if present, can prevent pinching of the patient as the backboard 1202 is placed under the patient. Examples of the disclosure, however, are not limited to a gap 1216 within the backboard 1202 and in some examples, the portions 1212 and 1214 of the backboard 1202 may abut each other.

In some examples, as shown in FIG. 12, the portions 1212 and 1214 of the backboard 1202 may be wedge-shaped or otherwise angled so that each portion 1212 and 1214 of the backboard 1202 gets thinner as the portions 1212 and 1214 approach each other. The wedge-shaped portions 1212 and 1214 can assist with placing the backboard 1202 under the patient.

Rather than having to separately position the backboard under the patient and then the upper portion, such as shown in FIG. 1, the mechanical CPR device 1200 can position the backboard 1202 and the central unit 1206 nearly simultaneously. That is, the support legs 1204 can rotate that the hinged joints 1210 to create a wider space between the support legs 1204. One portion 1212 or 1214 of the backboard 1202 can be slipped or placed under the patient while rotating the rest of the mechanical CPR device 1200 over the patient until the other portion 1212 or 1214 of the backboard 1202 can be placed under the patient.

For some patients, the support legs 1204 may be hinged wide by the joint 1210 so that the two portions 1212 and 1214 can be simultaneously scooped under the patient. No matter how the mechanical CPR device 1200 is positioned around the patient, a rescuer is able to quickly determine whether the compression mechanism 1208 is in the correct position while positioning the backboard 1202.

### EXAMPLES

Illustrative examples of the disclosed technologies are provided below. A particular configuration of the technologies may include one or more, and any combination of, the examples described below.

Example 1 includes a mechanical cardiopulmonary resuscitation (CPR) device, comprising: an alignment device structured to be positioned at a desired compression point of a chest of a patient; a backboard structured to be positioned under the patient and aligned with the alignment device; and an upper part having a compression mechanism structured to attach to the backboard.

Example 2 includes the mechanical CPR device of Example 1, wherein the alignment device includes a visual indication of a compression point target.

Example 3 includes the mechanical CPR device of Example 2, wherein the visual indication is a geometric shape.

Example 4 includes the mechanical CPR device of any of Examples 2-3, wherein the visual indication is a change in color.

Example 5 includes the mechanical CPR device of any of Examples 1-4, wherein the alignment device includes a strap that extends from the compression point toward a back of the patient.

Example 6 includes the mechanical CPR device of Example 5, wherein the strap extends from the compression point toward the backboard.

Example 7 includes the mechanical CPR device of any of Examples 5-6, wherein the strap is flexible.

Example 8 includes the mechanical CPR device of any of Examples 5-6, wherein the strap is rigid.

Example 9 includes the mechanical CPR device of any of Examples 5-8, wherein the strap includes an adhesive for adhering the strap to the patient.

Example 10 includes the mechanical CPR device of any of Examples 5-9, wherein the strap spans a lateral width of the backboard to permit visual alignment of the strap with the backboard.

Example 11 includes the mechanical CPR device of any of Examples 5-10, wherein the alignment device includes a visual indication of a compression point target.

Example 12 includes the mechanical CPR device of Example 11, wherein the visual indication is a geometric shape.

Example 13 includes the mechanical CPR device of any of Examples 11-12, wherein the visual indication is a change in color.

Example 14 includes the mechanical CPR device of any of Examples 1-13, wherein the alignment device includes a template to be placed on the chest of the patient having a compression point target.

Example 15 includes the mechanical CPR device of Example 14, wherein the compression point target is a hole in the template.

Example 16 includes the mechanical CPR device of any of Examples 14-15, wherein the compression point target comprises a suction cup structured to attach to a compression mechanism of the upper part.

Example 17 includes the mechanical CPR device of any of Examples 1-16, wherein the upper part includes a first leg and a second leg, each of the first leg and the second leg being structured to attach the compression mechanism to the backboard, the backboard comprising: a first connector structured to attach to the first leg; a second connector structured to attach to the second leg; and an elongated portion extending along an axis between the first connector and the second connector.

Example 25 includes a mechanical cardiopulmonary resuscitation (CPR) device, comprising: a backboard having a first sensor; an upper unit structured to attach to the backboard over the chest of the patient; a second sensor configured to attach to a back of a patient at a desired backboard location; and a processor configured to determine when the first sensor in the backboard and the second sensor are aligned.

Example 26 includes a backboard for a mechanical cardiopulmonary resuscitation (CPR) device, comprising: a first connector structured to attach to a first leg of the mechanical CPR device; a second connector structured to attach to a second leg of the mechanical CPR device; an elongated portion extending along an axis between the first connector and the second connector; and an alignment device coupled to the elongated portion configured to emit light to align the backboard with a desired compression point.

Example 27 includes the backboard of Example 26, wherein the alignment device includes one or more light emitting diodes or lasers.

Example 28 includes the backboard of any of Examples 26-27, wherein the alignment device is extendible from the elongated portion.

Example 29 includes the backboard of any of Examples 26-28, wherein the alignment device is further configured to alert a user when a patient is too small or too large for the mechanical CPR device.

Example 30 includes the backboard of any of Examples 26-29, wherein the alignment device is further configured to transmit a signal to a processor to determine an alignment of a compression mechanism.

Example 31 includes a mechanical cardiopulmonary resuscitation (CPR) device, comprising: an upper unit having a compression mechanism, the upper unit including a first leg and a second leg; a backboard, including: a first connector structured to attach to the first leg; a second connector structured to attach to the second leg; an elongated portion extending along an axis between the first connector and the second connector; and an alignment device configured to assist with aligning the backboard with a desired compression point.

Example 32 includes the mechanical CPR device of Example 31, wherein the alignment device includes one or more light emitting devices coupled to the elongated portion.

Example 33 includes the mechanical CPR device of Example 32, wherein the one or more light emitting devices includes light emitting diodes or light emitting lasers.

Example 34 includes the mechanical CPR device of any of Examples 31-33, wherein the alignment device is extendible and retractable from the elongated portion.

Example 35 includes the mechanical CPR device of any of Examples 31-34, wherein the alignment device is further configured to alert a user when a patient is too small or too large for the mechanical CPR device.

Example 36 includes the mechanical CPR device of any of Examples 31-35, further comprising a processor, wherein the alignment device is further configured to transmit a signal to the processor to determine an alignment of a compression mechanism.

Example 37 includes the mechanical CPR device of Example 36, wherein the processor is further configured to detect a position change of the compression mechanism based on the signal transmitted from the alignment device.

Example 38 includes the mechanical CPR device of any of Examples 31-37, wherein the alignment device includes a camera.

Example 39 includes the mechanical CPR device of Example 38, further comprising a processor, wherein the elongated portion includes a plurality of markers to determine a patient size and the alignment device is configured to transmit a picture of the patient within the backboard and the processor can alert a user whether the patient is outside a size range of the mechanical CPR device based on the picture and the plurality of markers.

Example 40 includes the mechanical CPR device of any of Examples 31-39, wherein the alignment device includes load sensors within the elongated portion.

Example 41 includes a mechanical cardiopulmonary resuscitation (CPR) device, comprising: a central unit having a compression mechanism; a first leg attached to the central unit, the first leg including one or more attachment devices to attach the first leg to a floor supporting a patient; and a second leg attached to the central unit, the second leg including one or more attachment devices to attach the second leg to the floor supporting the patient.

Example 42 includes the mechanical CPR device of Example 41, wherein the attachment device is a suction cup.

Example 43 includes the mechanical CPR device of any of Examples 41-42, wherein the attachment device includes adhesive.

Example 44 includes the mechanical CPR device of any of Examples 41-43, wherein the attachment device includes foot pedal extensions structure to receive a weight of a user.

Example 45 includes a mechanical cardiopulmonary resuscitation (CPR) device, comprising: a central unit having a compression mechanism; a first leg attached to the central unit; a first backboard attached to the first leg; a second leg attached to the central unit; and a second backboard attached to the second leg.

Example 46 includes the mechanical CPR device of Example 45, wherein the first backboard attaches to the first leg by a hinge.

Example 47 includes the mechanical CPR device of Example 46, wherein the second backboard attaches to the second leg by a hinge.

Example 48 includes the mechanical CPR device of Example 45, wherein the first leg is attached to the central unit by a hinge and the first backboard is fixedly attached to the first leg.

Example 49 includes the mechanical CPR device of any of Examples 45-48, wherein the first backboard and the second backboard are wedge-shaped.

Example 50 includes the mechanical CPR device of any of Examples 45-49, wherein the first backboard and the second backboard are structured to be positioned under a back of a patient without touching each other.

*****

For purposes of this description, certain aspects, advantages, and novel features of the examples of this disclosure are described herein. Features, integers, characteristics, compounds, chemical moieties or groups described in conjunction with a particular aspect, configuration, or example of the disclosure are to be understood to be applicable to any other aspect, configuration or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The disclosure is not restricted to the details of any foregoing examples. The disclosure extends to any novel one, or any novel combination, of the features disclosed in this specification (including any accompanying claims, abstract and drawings), or to any novel one, or any novel combination, of the steps of any method or process so disclosed.

Although the operations of some of the disclosed methods are described in a particular, sequential order for convenient presentation, it should be understood that this manner of description encompasses rearrangement, unless a particular ordering is required by specific language. For example, operations described sequentially may in some cases be rearranged or performed concurrently. Moreover, for the sake of simplicity, the attached figures may not show the various ways in which the disclosed methods can be used in conjunction with other methods.

As used herein, the terms “a”, “an”, and “at least one” encompass one or more of the specified element. That is, if two of a particular element are present, one of these elements is also present and thus “an” element is present. The terms “a plurality of” and “plural” mean two or more of the specified element. “Generally” or “approximately” as used herein means a variance of 10%.

As used herein, the term “and/or” used between the last two of a list of elements means any one or more of the listed elements. For example, the phrase "A, B, and/or C" means "A," "B," "C," "A and B," "A and C," "B and C," or "A, B, and C."

As used herein, the term “coupled” generally means physically coupled or linked and does not exclude the presence of intermediate elements between the coupled items absent specific contrary language.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the disclosure have been illustrated and described for purposes of illustration, it will be understood that various modifications may be made without departing from the spirit and scope of the disclosure. Accordingly, the disclosure should not be limited except as by the appended claims.

Aspects of the disclosure may operate on particularly created hardware, firmware, digital signal processors, or on a specially programmed computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a computer readable storage medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

I or we claim:

1. A mechanical cardiopulmonary resuscitation (CPR) device, comprising:
an alignment device structured to be positioned at a desired compression point of a chest of a patient;
a backboard structured to be positioned under the patient and aligned with the alignment device; and
an upper part having a compression mechanism structured to attach to the backboard.

2. The mechanical CPR device of claim 1, wherein the alignment device includes a visual indication of a compression point target.

3. The mechanical CPR device of claim 2, wherein the visual indication is a geometric shape.

4. The mechanical CPR device of claim 2, wherein the visual indication is a change in color.

5. The mechanical CPR device of claim 1, wherein the alignment device includes a strap that extends from the compression point toward a back of the patient.

6. The mechanical CPR device of claim 5, wherein the strap extends from the compression point toward the backboard.

7. The mechanical CPR device of claim 5, wherein the strap is flexible.

8. The mechanical CPR device of claim 5, wherein the strap is rigid.

9. The mechanical CPR device of claim 5, wherein the strap includes an adhesive for adhering the strap to the patient.

10. The mechanical CPR device of claim 5, wherein the strap spans a lateral width of the backboard to permit visual alignment of the strap with the backboard.

11. The mechanical CPR device of claim 5, wherein the alignment device includes a visual indication of a compression point target.

12. The mechanical CPR device of claim 11, wherein the visual indication is a geometric shape.

13. The mechanical CPR device of claim 11, wherein the visual indication is a change in color.

14. The mechanical CPR device of claim 1, wherein the alignment device includes a template to be placed on the chest of the patient having a compression point target.

15. The mechanical CPR device of claim 14, wherein the compression point target is a hole in the template.

16. The mechanical CPR device of claim 14, wherein the compression point target comprises a suction cup structured to attach to a compression mechanism of the upper part.

17. The mechanical CPR device of claim 1, wherein the upper part includes a first leg and a second leg, each of the first leg and the second leg being structured to attach the compression mechanism to the backboard, the backboard comprising:
a first connector structured to attach to the first leg;
a second connector structured to attach to the second leg; and
an elongated portion extending along an axis between the first connector and the second connector.
